(19) United States
(12) Patent Application Publication
(10) Pub. No.: US 2006/0015532 A1
(43) Pub. Date: Jan. 19, 2006

(54) Method and system for integrated foodservice management

(76) Inventor: L. Warner Mizell, Austin, TX (US)

Correspondence Address: Warner Mizell, 3007 Rivercrest Dr., Austin, TX, 78746, US

(21) Appl. No.: 10/894,085

(22) Filed: Jul. 19, 2004

(51) Int. Cl. G06F 17/00

(52) U.S. Cl. 707/104.1

(57) ABSTRACT

The method and system of the present invention provides an improved technique for foodservice management. Information is aggregated from a variety of sources into a centralized computerized database. Thereafter, foodservice management tasks are scheduled and performed. Information from the centralized computerized database is used in the performance of the foodservice management tasks and information relating to the foodservice management tasks is added to the centralized computerized database. Subsequent changes to the foodservice environment and the results of continuous management are also recorded into the centralized computerized database. As a result, a plethora of information is available within said database for the purpose of managing foodservice operations.

### PRIORITY STATEMENT UNDER 35 U.S.C. § 119 & 37 C.F.R. §1.78

This non-provisional application claims priority based upon prior U.S. Provisional Patent Application filed Jul. 18, 2003 in the name of Warner Mizell, entitled “Method and System for Web Based Foodservice Management.”

### BACKGROUND OF THE INVENTION

1. Technical Field of the Invention

The present invention relates generally to a method and system for integrated foodservice management. More particularly, the present invention provides a means for aggregating information into a centralized computerized database and using that information to schedule and perform foodservice management tasks. In addition, information from the centralized computerized database is used in the performance of the foodservice management tasks and information relating to the foodservice management tasks is added to the centralized computerized database. Subsequent changes to the foodservice environment and the results of continuous management are also recorded into the centralized computerized database. As a result, a plethora of information is available within said database for the purpose of managing foodservice operations.

2. Description of Related Art

Consumption of meals prepared away from home continues to grow as a percentage of total meals, and the number of multi-unit foodservice chains continues to proliferate. Managing a chain of foodservice stores is complex, due to the following factors: number of ingredients, perishables nature of inventory, persistent ordering challenge, changing prices, food shrinkage/theft, training staff in high turnover environment. The available methods and systems for foodservice management focus on discrete subsets of the management problem, and do not provide a solution that addresses the entire challenge in a practical fashion.

What does not exist is a method that simultaneously 1) structures and automates specific tasks, 2) comprehends the full extent of information elements used, and 3) provides a platform and to collect, validate, and share that full range of information in real time across the entire foodservice enterprise. The result is sub-optimal management of supply chain, food cost, and labor cost; lack of control over vendors and employees; disproportionate amount of management time spent on back office functions vs. customer facing functions; excessive time lag between a change in the environment and visibility/corrective response to that change (because the information about the change is stale and corrective action is too late). There is, therefore, a need for an improved method and system for integrated foodservice management.

### SUMMARY OF THE INVENTION

The present invention addresses the need for an improved method and system for integrated foodservice management. The present invention provides a means for aggregating information into a centralized computerized database and using that information to schedule and perform foodservice management tasks. In addition, information from the centralized computerized database is used in the performance of the foodservice management tasks and information relating to the foodservice management events is added to the centralized computerized database. Subsequent changes to the foodservice environment and the results of continuous management are also recorded into the centralized computerized database. As a result, a plethora of information is available within said database for the purpose of managing foodservice operations. Using the invention, foodservice organizations are able to rationalize and improve operations, accurately manage the supply chain, and focus more attention to the front of the store and addressing customer needs.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 is a foodservice management workflow flow diagram of typical task categories and information categories.

FIG. 2 is a foodservice management workflow diagram showing the preferred method of foodservice management according to the present invention.

FIG. 3 is a foodservice management workflow diagram showing the preferred method of inventory and supply chain management according to the present invention.

FIG. 4 is a screen display showing store information aggregated during the method for integrated foodservice management.

FIG. 5 is a screen display showing store information aggregated during the method for integrated foodservice management.

FIG. 6 is a screen display showing vendor information aggregated during the method for integrated foodservice management.

FIG. 7 is a screen display showing vendor item information aggregated during the method for integrated foodservice management.

FIG. 8 is a screen display showing menu information aggregated during the method for integrated foodservice management.

FIG. 9 is a screen display showing recipe information aggregated during the method for integrated foodservice management.

FIG. 10 is a screen display showing recipe detail information aggregated during the method for integrated foodservice management.

FIG. 11 is a screen display showing the task to create a purchase order during the preferred method of inventory and supply chain management.

FIG. 12 is a screen display showing the task to electronically transmit a purchase order during the preferred method of inventory and supply chain management.

FIG. 13 is a screen display showing the task to receive a delivery and reconcile to a purchase order during the preferred method of inventory and supply chain management.

FIG. 14 is a screen display showing the task to capture sales information during the preferred method of inventory and supply chain management.

FIG. 15 is a screen display showing the task to count inventory amounts on hand and calculate shrinkage values during the preferred method of inventory and supply chain management.

### DETAILED DESCRIPTION OF THE EXEMPLARY EMBODIMENTS OF THE INVENTION

The numerous innovative teachings of the present application will be described with particular reference to the presently preferred exemplary embodiments. However, it should be understood that these embodiments provide only a few examples of the many advantageous uses of the innovative teachings herein. In general, statements made in the specification of the present application do not necessarily delimit any of the various claimed inventions. Moreover, some statements may apply to some inventive features, but not to others.

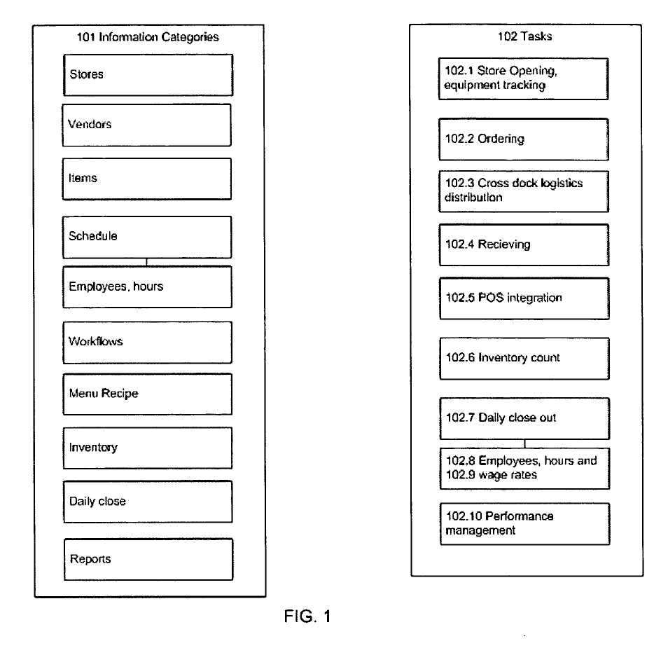

FIG. 1 illustrates a typical foodservice management workflow. The tasks listed 102 are typically performed ad hoc, using a variety of disjointed systems, and/or following a paper-based workflow. Store openings 102.1 are typically managed separately from store operations using non-Web-based project management techniques. As equipment is installed at the stores, the equipment types and serial numbers are typically recorded in a separate asset management system of paper file. Ordering food and goods for foodservice operations 102.2 is typically handled by each store manager via phone calls to each vendor, or using each vendors' proprietary online ordering system (each of which are separate from each other and are separate from the stores' systems). Performing logistics and cross docking 102.3 to move goods to the store is typically managed in a separate system, with no good method to communicate stock outs to the store, and no good method to place RFID (radio frequency identification) tags on selected boxes. Receiving of ordered goods into the store 102.4 is typically performed based on the paper invoice presented by the delivery man; reconciliation to actual goods received is generally handled by handwritten notes on that paper invoice; thus, the corrections are not comprehended systematically. Uploading sales data electronically from the point-of-sale (POS) device 102.5 is typically performed using the POS vendor's proprietary system, and the resulting data is isolated from other cost and inventory count data; thus, the POS information is typically used only for sales accounting and analysis, and is typically not leveraged for real-time profitability by menu item analysis, or real-time shrinkage analysis (shrinkage is loss of inventory due to overportioning, employee theft, spoilage, etc.). Inventory counting and shrinkage tracking 102.6 is typically a labor intensive, arduous task performed by the store manager using a pencil and clipboard, and faxing the results to a central accounting department for data entry. There are no good methods to leverage in-store RFID (radio frequency identification) tag technology to assist in the automated counting of inventory on hand. The counting task is so arduous that often inventory is counted only once a month or even once a year. Typically, the shrinkage tracking analysis, which requires inventory counts as an input, is performed only periodically and after a substantial time lapse (i.e., not in real time), so it is typically too late to take corrective action on immediate shrinkage problems. Using existing methods, the amount of data involved from several disparate sources (order/receive data, POS data converted to vendor items via recipe tables, and inventory count data), the infrequency of inventory counts, and the complex calculations involved make it prohibitive to continuously calculate shrinkage in a useful way. The infrequency of inventory counting makes the practice of auto-replenishment (where a system auto calculates quantities of each item to be ordered) inaccurate and not viable. The task of performing daily close out 102.8 is typically performed on paper and often faxed to a central accounting office. Employee hours worked 102.9 is recorded in a separate time tracking punch clock system, typically in a paper punch card format, and sometimes in the POS device (there is no good method to validate that the actual employee is the one inputting his hours). Employee wage rates are typically recorded in a separate paper file. Finally, the task of managing store performance 102.10 is typically an ad hoc analysis, with different store managers using different techniques. Typically, the focus of day-to-day performance is based on daily sales, since that data is easily obtained. Typically, real-time data regarding store profitability, labor productivity, and shrinkage, are not available to help manage the stores, because the data to calculate the metrics is in disparate places, and the calculations required are not practical to make on a daily basis using existing methods. Thus, a store manager will typically not know the impact of the rising cost of meat, for example, or that an employee is overportioning, until an end of month report is generated, which is typically too late to correct the situation.

Similarly, the recording and calculation of information is managed ad hoc, using a variety of disjointed systems, and/or on paper. Information categories listed in 101 are each essential to the foodservice management task, and are often interdependent, yet the data elements typically do not exist in a single database for calculations, information management, and reporting. Using existing methods, the time and effort required to get the data into a database (through hand keying) is not practical, and is therefore typically not even attempted. The point is that the typical, general methods for foodservice management are disjointed and inefficient, and do not give the foodservice manager the much-needed tools to automate and optimize the operations of a foodservice store or chain of stores.

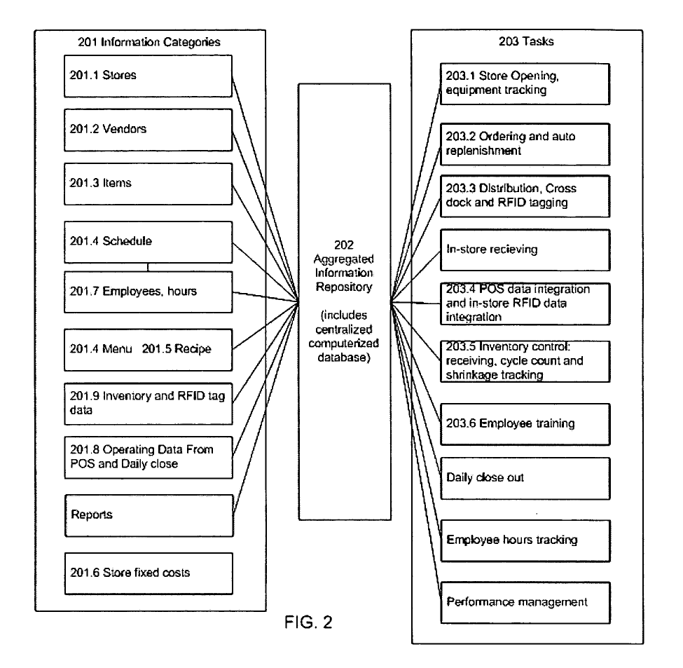

The preferred method for integrated foodservice management according to the present invention is shown in FIG. 2. The range of tasks 203 is similar to the prior art. Under this preferred embodiment, it is critical to provide the person performing each task with a Web-based page to help him/her accurately perform the task with minimal effort. As he/she performs, the present invention automatically structures/validates the task, and with no additional effort, captures information about the task and makes that information immediately available to other relevant tasks. The foundation of the present invention is a centralized computerized database that serves the tasks and captures/aggregates/validates information in real time, and makes the accurate information useful and consistent across the several tasks.

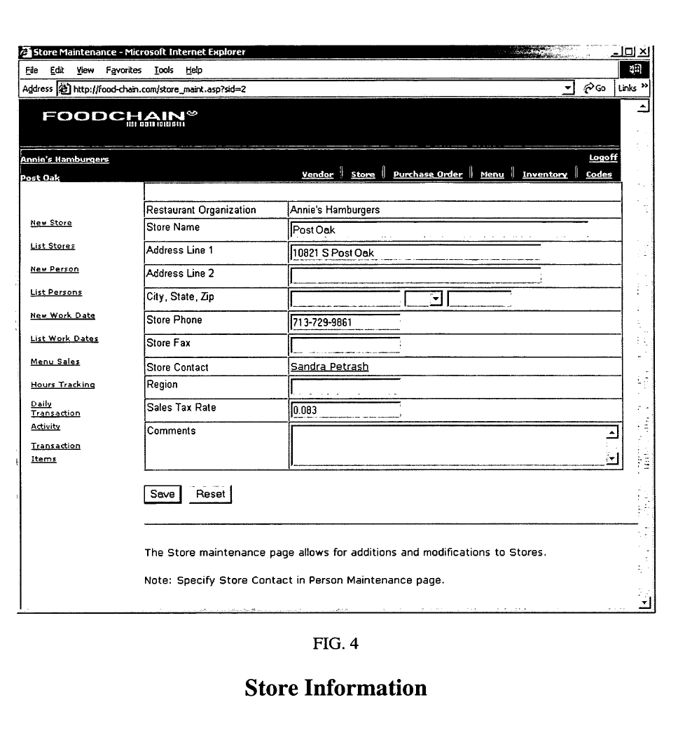

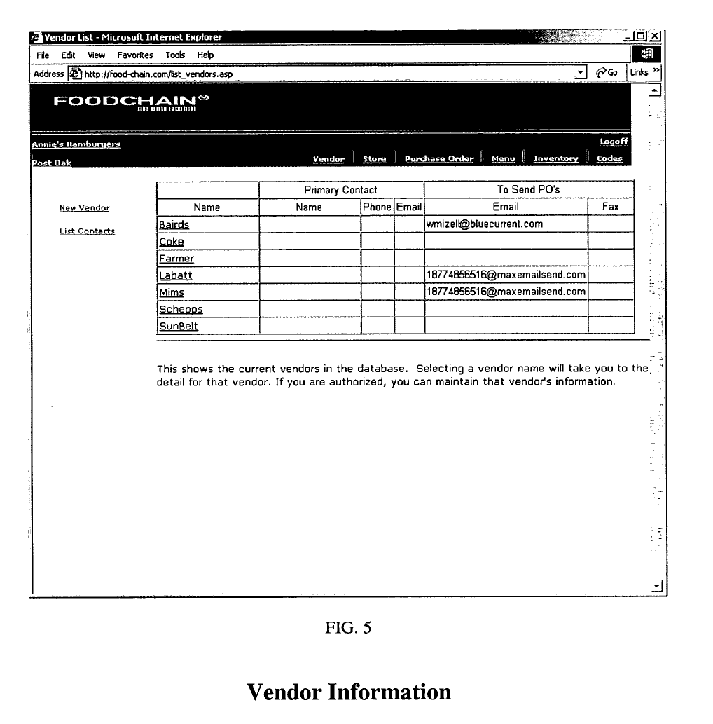

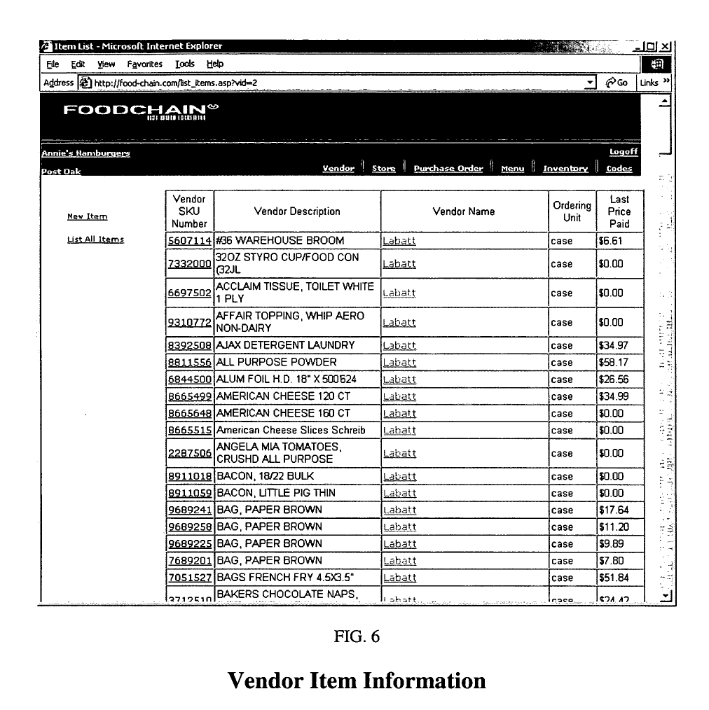

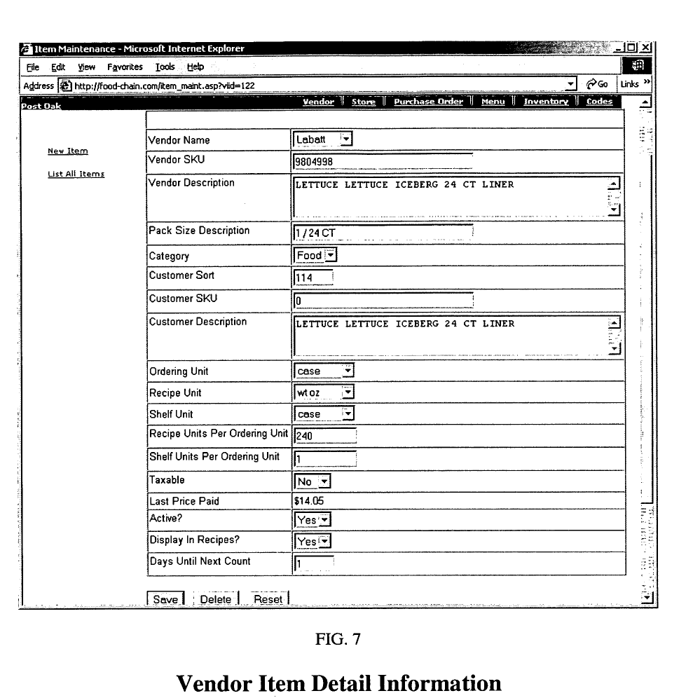

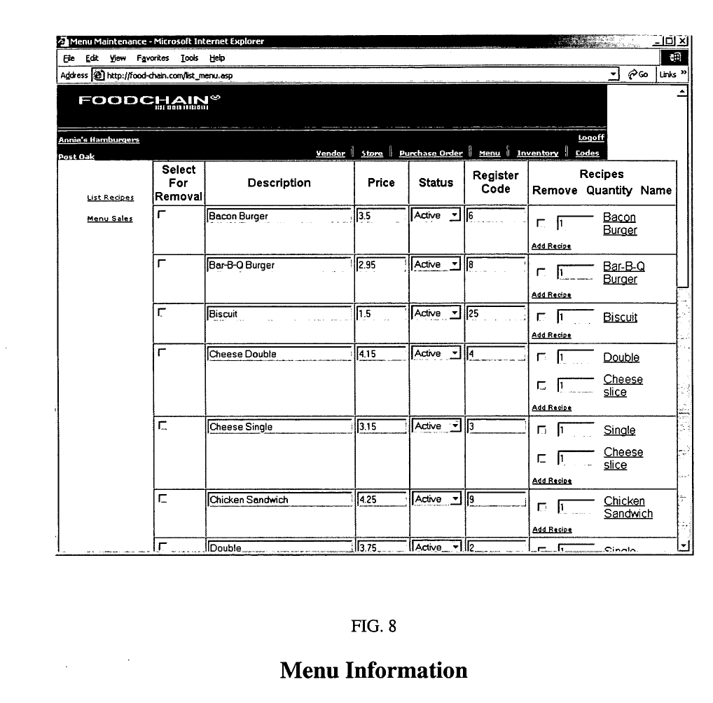

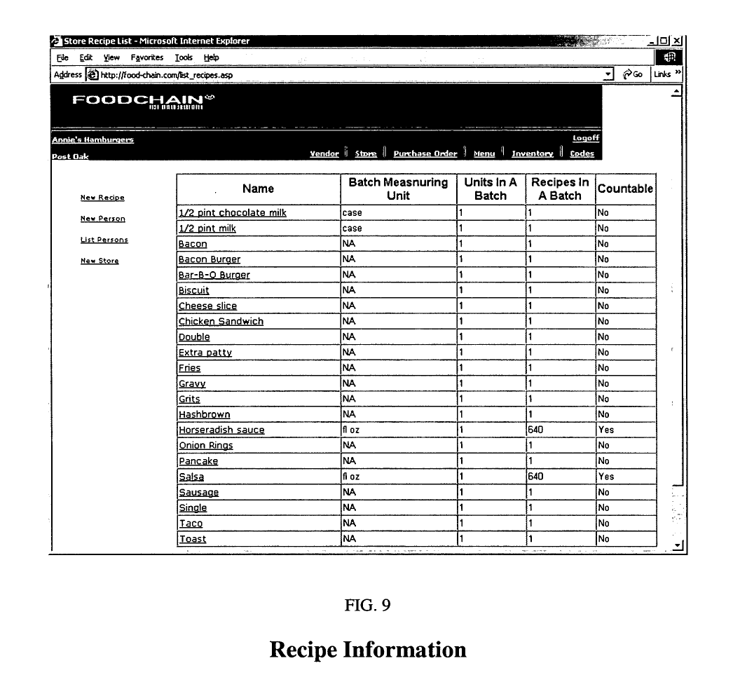

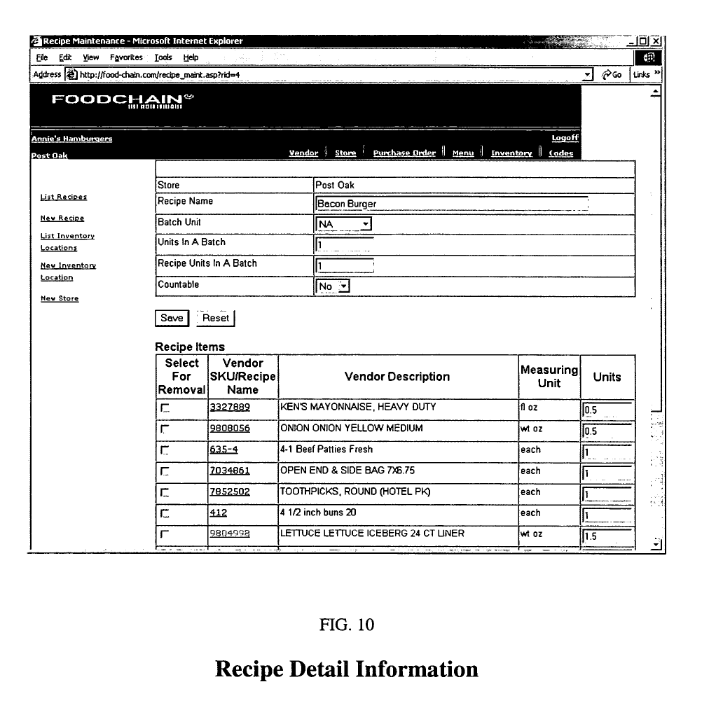

The backbone of the present invention is the aggregated information repository 202 and its information model. It is instructive to examine the types of information 201 aggregated as part of the preferred embodiment. For example, store data 201.1 may include store name, address, square footage, seating/parking capacity, drive through configuration, blueprint images, lessor, lease terms, capital improvements, manager name, division, employee roles, etc (see FIG. 4). Vendor data 201.2 may include vendor name, address, contact info, payment terms, tax rate, etc (see FIG. 5). Vendor items data 201.3 may include corporate approved item catalog with most recent cost, portion, par level, reorder point, lead times, tax treatment, cycle count frequency, etc (See FIGS. 6 and 7). Menu data 201.4 may include menu items and their prices, as well as associated receipes (see FIG. 8). Recipe data 201.5 may include a structure such that for each menu item, a build-up of the vendor items that make up the menu item, the portion of each (including batch recipes), as well as preparation instructions (see FIGS. 9 and 10). Store-level fixed cost data 201.6 may include data for rent, insurance, utilities, etc. Employee data 201.7 may include name, address, W-2 and I-9 details, hourly rate, skills/performance assessment, training results, and references. Operating data 201.8 may include sales data from various point of sale devices. Inventory data 201.9 may include a structure that tracks results of periodic inventory counts, and which may include information detected from RFBD tags present on boxes and/or/pallets.

The range of tasks 203 begins with planning, project management, and opening of new foodservice stores 203.1. The preferred method may include the workflow of real estate selection, site design, permitting, construction, subcontracting, and procurement of fixtures/equipment, with an emphasis on tracking costs.

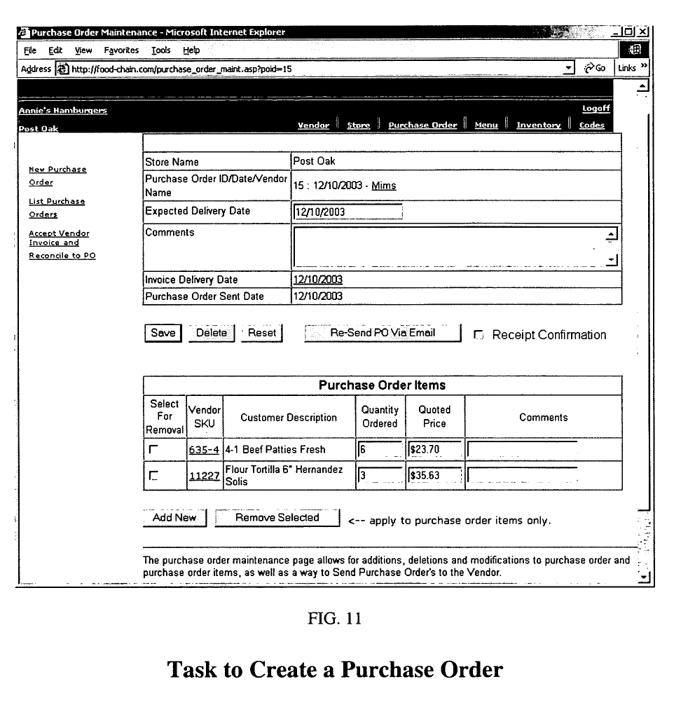

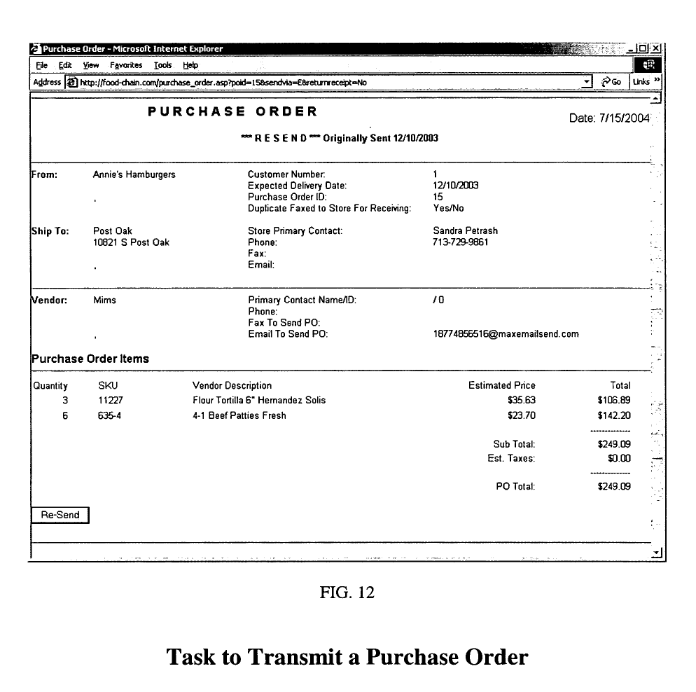

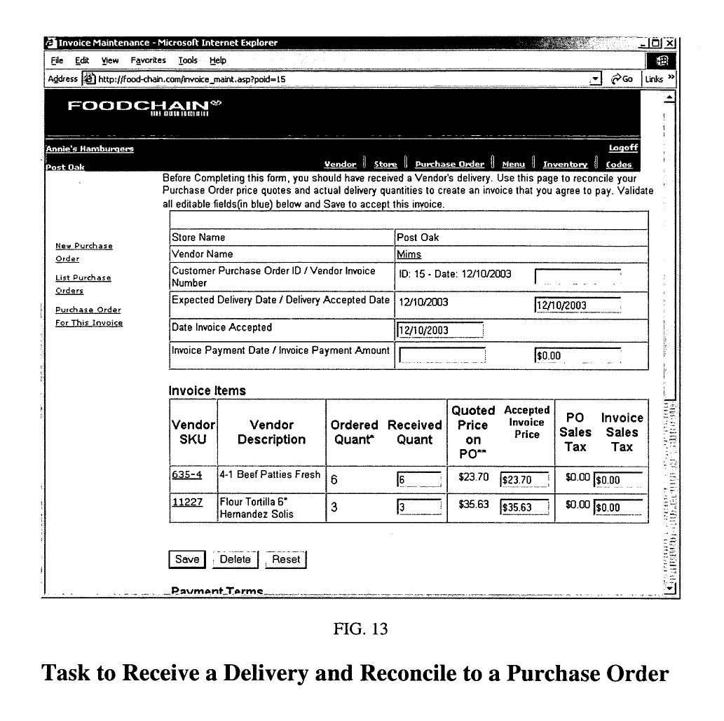

For opened stores, the next task enables the foodservice organization to place online orders 203.2, sending automated purchase order information to multiple vendors via fax, email, and/or direct data transfer (see FIGS. 11 and 12). Note that the foodservice organization has complete control over this electronic ordering task and is not dependent on a vendor's system or a third party clearinghouse system (which requires adherence to a central skuing system and loss of control and data). Orders are based on corporate purchasing standards cataloged in the repository, and the latest quoted costs. The store can leverage an automated replenishment method that saves time and improves guesswork in how much to order. As orders are placed, the repository automatically captures current cost and feeds it to the food-costing portion of the repository in real time. The solution manages inter-store transfers, and includes a receiving and reconciliation task to verify that deliveries match orders (see FIG. 13). The repository may include an inter-organization price list that different organizations can opt into to share price data on various vendor items, to assist them in finding the best price.

The next set of tasks is foodservice distribution, logistics, and cross-dock operations 203.3. The same information used to anticipate automated replenishment is shared up the supply chain with relevant people and organizations. Since the supply chain has visibility to demand in the near future, it can proactively balance and optimize the supply and logistics needed to satisfy the demand. Tasks that may be included are 1) prepping or processing certain items (breaking down pallets, shredding lettuce) and 2) affixing a commercially-available RFID tag to each box and/or pallet before introducing it to the foodservice store environment. The RFID tag enables the foodservice organization to detect information about the box/pallet (location, sku, temperature) as it travels the supply chain, is processed, and sits in inventory in a store (thus precluding the need for the arduous physical counting of boxes).

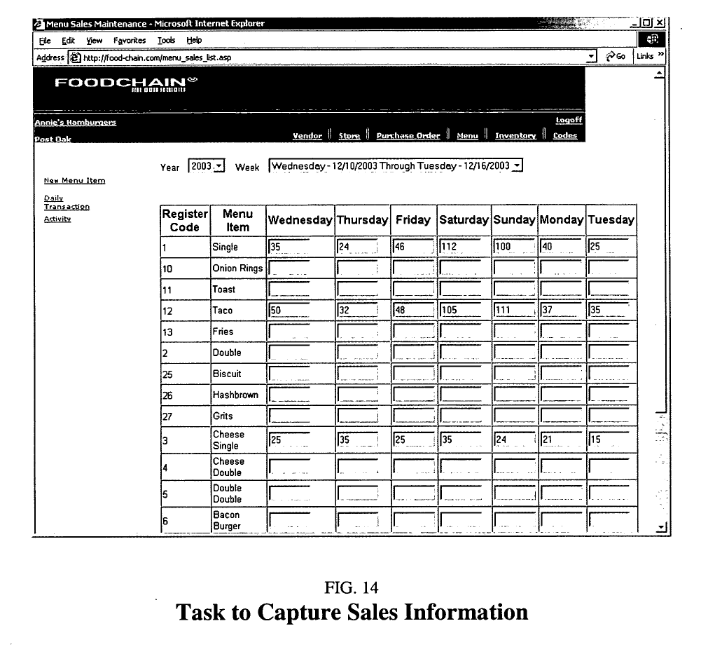

The next task is using a point-of-sale (POS) device to register in-store transactions and communicate those transactions to the repository 203.4 (see FIG. 14). In the preferred method, the device uses an attached, commercially available antenna to detect RFID tags on boxes and on employee badges (to grant certain employees with access rights to the device), and to communicate the data to the repository. The same antenna may be used to serve customers with wireless broadband access to the Internet while they dine.

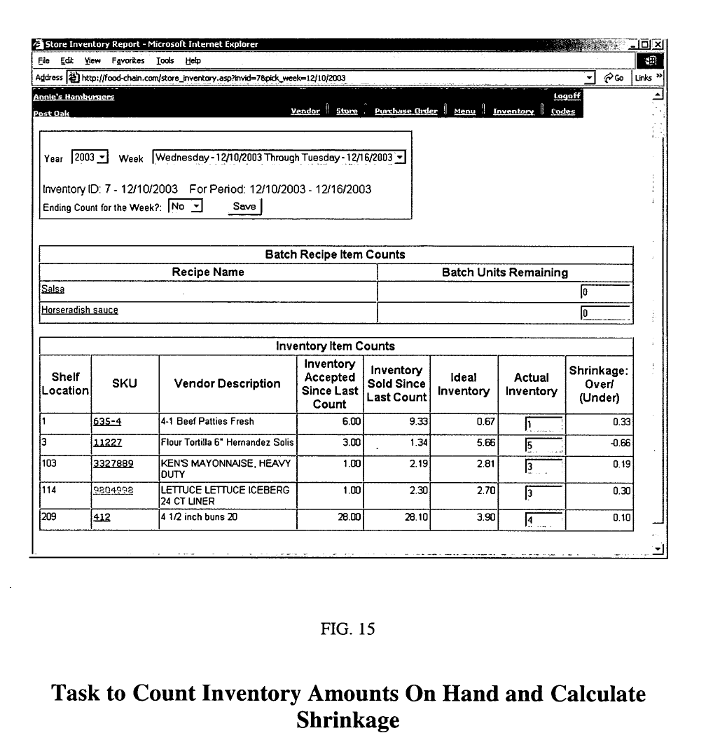

The next task is inventory control 203.5. Because the repository keeps track of amounts ordered/received as well as amounts sold (via POS) in real time, it provides a calculation for perpetual expected inventory on hand, in real time. The task's workflow provides a way for management to specify which items the store manager is to count each day (enabling the practice of daily cycle counting, which is not feasible under typical foodservice management methods), and as the counter enters the quantity on hand, the repository immediately compares the quantity on hand to the expected amount. The difference is calculated as shrinkage, and multiplied times the last price paid for that item to derive a shrinkage value. Attention to this shrinkage value, and minimizing it, is a key area to improve food costs. Real time variance reporting enables management to isolate problem areas and take corrective action to control shrinkage. Note that the perpetual expected inventory is calculated automatically by the repository, based on data captured during inventory, order, and sales tasks, and does not require labor-intensive data entry or calculations (see FIG. 15).

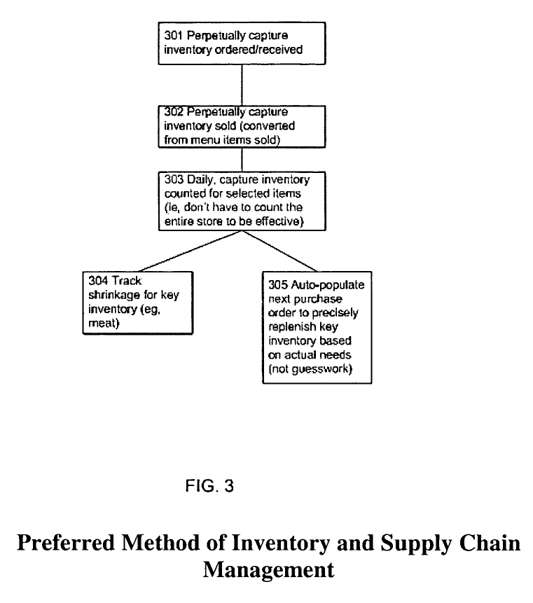

FIG. 3 summarizes these inventory and supply chain tasks as a continuous workflow: 301 Perpetually capture inventory ordered/received; 302 Perpetually capture inventory sold (converted from menu items sold); 303 Daily, capture inventory counted for selected items (i.e., don't have to count the entire store to be effective); 304 Track shrinkage for key inventory (e.g., meat); 305 Auto-populate next purchase order to precisely replenish key inventory based on actual needs (not guesswork).

The next task is employee training 203.6. As a new employee is on-boarded, he/she is asked to log on to a Web page, complete his/her employee data, and take a Web based computer-training course. The successful completion of the course is tracked and monitored by management.

In the preferred embodiment, all stores comprising a foodservice organization would use the methods described above, and each would interact with the common centralized repository. Tasks would be standardized across all stores, and operational information would be calculated across all stores. Thus, management would be empowered to monitor profitability across all stores, manage problems and opportunities proactively and in real-time, and optimize the foodservice environment.

We claim:

1. A method for integrated foodservice management comprising the steps of:
Aggregating information into a centralized computerized database;
Performing foodservice management tasks;
Using said information in performing said foodservice management tasks;
Recording information from said foodservice management task into said centralized computerized database;
Managing ongoing foodservice operations and changes to the environment through information available in said computerized database.

2. The method of claim 1 wherein said information is selected from the group consisting of store information, vendor information; vendor item information, schedule information, employee information and hours worked, menu and recipe information, inventory information, and daily close information.

3. The method of claim 1 wherein said centralized computerized database is a relational database.

4. The method of claim 1 wherein said foodservice management task is selected from the group consisting of store opening and equipment tracking, ordering and auto-replenishment, cross dock distribution and RFID tagging; in-store receiving;
integrating operating data from POS device; integrating data from RFID tags;
daily close out; employee training, employee hours tracking, and performance management.

5. The method of claim 1 wherein said centralized database is located remotely from the location of said foodservice management task.

6. The method of claim 1 wherein said information is transmitted to said centralized computerized database through the Internet.

7. The method of claim 1 wherein said information is transmitted to said centralized computerized database through a local or wide area network.

8. The method of claim 1 wherein said information is transmitted to said centralized computerized database through Web services.

9. The method of claim 6, 7, or 8 wherein said information is transmitted to said centralized computerized database through secure, encrypted transmission.

10. The method of claim 1 wherein said management is conducted on a continues basis and said changes are made to said centralized computerized database on a real-time basis.

11. The method of claim 1 wherein said method includes the generation of reports derived from information located in said centralized computerized database.

12. The method of claim 1 wherein such reports are selected from the group consisting of store-level profit and loss reports, sales trend reports, shrinkage reports, labor productivity reports, menu item trends and profitability reports, ideal food cost vs. actual food cost, variance reports, and reports that roll up to the divisional level and drill down to the store level, and reports that disseminate information to other systems such as accounting or payroll processing.

13. The method of claim 1 wherein said method provides a means for translating said information in said centralized computerized database into a common language

14. A system for integrated foodservice management comprising the steps of:
Aggregating information into a centralized computerized database;
Performing foodservice management tasks;
Using said information in performing said foodservice management tasks;
Recording information from said foodservice management task into said centralized computerized database;
Managing ongoing foodservice operations and changes to the environment through information available in said computerized database.

15. The system of claim 14 wherein said information is selected from the group consisting of store information, vendor information; vendor item information, schedule information, employee information and hours worked, menu and recipe information, inventory information, and daily close information.

16. The system of claim 14 wherein said centralized computerized database is a relational database.

17. The system of claim 14 wherein said foodservice management task is selected from the group consisting of store opening and equipment tracking, ordering and auto-replenishment, cross dock distribution and RFID tagging; in-store receiving;
integrating operating data from POS device; integrating data from RFID tags;
daily close out; employee training, employee hours tracking, and performance management.

18. The system of claim 14 wherein said centralized database is located remotely from the location of said foodservice management task.

19. The system of claim 14 wherein said information is transmitted to said centralized computerized database through the Internet.

20. The system of claim 14 wherein said information is transmitted to said centralized computerized database through a local or wide area network.

21. The system of claim 14 wherein said information is transmitted to said centralized computerized database through Web services.

22. The system of claim 19, 20, or 21 wherein said information is transmitted to said centralized computerized database through secure, encrypted transmission.

23. The system of claim 14 wherein said management is conducted on a continuous basis and said changes are made to said centralized computerized database on a real-time basis.

24. The system of claim 14 wherein said system includes the generation of reports derived from information located in said centralized computerized database.

25. The system of claim 14 wherein such reports are selected from the group consisting of store-level profit and loss reports, sales trend reports, shrinkage reports, labor productivity reports, menu item trends and profitability reports, ideal food cost vs. actual food cost, variance reports, and reports that roll up to the divisional level and drill down to the store level, and reports that disseminate information to other systems such as accounting or payroll processing.

26. The system of claim 14 wherein said system provides a means for translating said information in said centralized computerized database into a common language.

27. A method for foodservice inventory and supply chain management comprising the steps of:
Inputting a catalog of vendors, vendor items, menus, and recipes into the centralized computerized database;
Generating recommended vendor item order replenishment quantities and placing purchase orders;
Reconciling actual items received from vendors versus items ordered;
Inputting sales results of menu items sold;
Inputting cycle counts of inventory on hand;
Calculating and managing shrinkage.

28. The method of claim 27 wherein said orders are transmitted electronically via fax, email, and/or direct data transfer from the centralized computerized database, and the details of said order are captured in real time.

29. The method of claim 27 wherein said cycle counting includes the ability to specify the counting frequency of each item (e.g., daily, weekly, monthly) in real time, thus focusing counting effort on high value or out-of-control-items; as well as the ability to specify count tolerances vs. expected quantity on hand.

30. The method of claim 27 wherein said shrinkage and replenishment values for each item are derived from values in the group consisting of: last inventory count of that item, plus inventory accepted since last inventory count; minus inventory sold since last inventory count (in turn derived from POS sales data), using the last price paid for each inventory item (based on orders); in such manner that each inventory cycle count will autocorrect the method at the item level, that a cycle count of each item is not required within a period for the method to work, that the cumulative value of shrinkage can be derived within a counting period based on those items that are counted during the period (i.e., not requiring a comprehensive count of all items for the method to work); and that replenishment values are improved and made more accurate by the most recent cycle count of that item.
